(19) United States
(12) Patent Application Publication
(10) Pub. No.: US 2018/0001951 A1
(43) Pub. Date: Jan. 4, 2018

(54) MOUNTING ARM FOR MOTORCYCLE FLOORBOARD AND FOOT PEG

(71) Applicant: Ciro, LLC, Hudson, WI (US)

(72) Inventor: Darron B. May, Stillwater, MN (US)

(21) Appl. No.: 15/199,033

(22) Filed: Jun. 30, 2016

(51) Int. Cl. B62J 25/00

(52) U.S. Cl. CPC B62J 25/00; Y10T 74/20918

(57) ABSTRACT

A motorcycle mounting arm has a support body, a first end of which includes a base for attachment to a motorcycle end cap. The support body has a second end, spaced from the first end that includes a mounting site for mounting a foot peg assembly. The support body includes a tab between the first and second ends for connection to a floorboard, to support a portion of the floorboard relative to the motorcycle frame.

### BACKGROUND

A touring style motorcycle commonly includes floorboards that are mounted on opposite sides of the motorcycle frame generally below the seat of the operator. The floorboards support the operator's feet when the motorcycle is being ridden. A secondary foot rest, known as a foot peg, may also be mounted to a motorcycle above and forward from the floorboards, to provide a place to support the operator's feet with the operator's legs extended, such as on long highway trips. On touring style motorcycles, foot pegs are commonly mounted to a roll bar secured to the front end of the motorcycle frame forward of the floorboards. The roll bar extends laterally on either side of the motorcycle frame a greater distance than the floorboards. A windbreak for the operator's legs, known as a fairing lowers, is commonly mounted to the roll bar. An alternative location for mounting a foot peg to a touring motorcycle equipped with floorboards, other than by use of the motorcycle roll bar, would be a beneficial improvement and would provide motorcycle operators with options for varying the location and hence comfort in using foot pegs.

### SUMMARY

A motorcycle mounting arm comprises an arm body having a length, a first end and a second end spaced from the first end. The first end has first and second attachment locations for connecting the mounting arm to an end cap of the motorcycle. The second end has a mounting site for a foot peg assembly. The arm body further has a tab between the first and second ends that is connectable to a portion of a motorcycle floorboard. The arm body has an axis that lies at an angle relative to the first and second attachment locations.

### BRIEF DESCRIPTION OF THE DRAWINGS

FIG. 1 is a top perspective view of a mounting arm for supporting a motorcycle floorboard and a foot peg assembly.

FIG. 2 is an end perspective view of the mounting arm of FIG. 1.

FIG. 3 is a rear side view of the mounting arm of FIG. 1

FIG. 4 is a top side view of the mounting arm of FIG. 1.

FIG. 5 is a top perspective view of the mounting arm of FIG. 1 with a foot peg assembly shown in phantom.

FIG. 6 is an exploded front perspective view of a portion of a motorcycle frame environment for connecting the mounting arm of FIG. 1.

### DETAILED DESCRIPTION

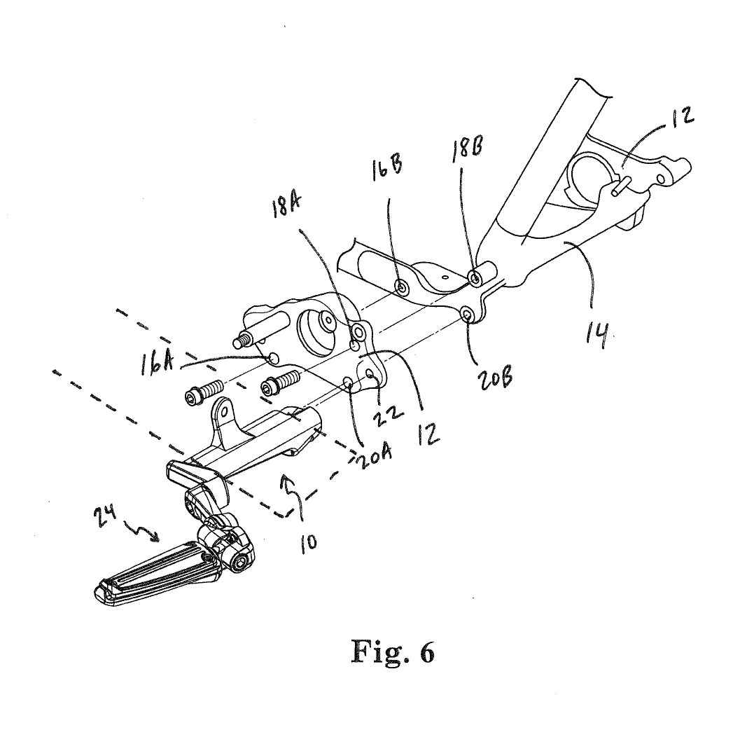

Generally, as shown in FIG. 6, a touring motorcycle made by Harley Davidson® includes two frame attachments, commonly referred to as an end cap 12, that are secured on opposite sides of a lower front portion of the motorcycle frame 14. Applicant's mounting arm 10 is designed for attachment to the end caps 12, and hence to the frame 14. Each end cap 12 has a generally planar surface with spaced attachment holes 16A, 18A and 20A that align with mounting holes 16B, 18B and 20B, respectively on the frame 14, for securing the end cap 12 to the frame 14 with threaded fasteners. End caps 12 function in part as a mounting structure for an engine mounting bracket (not shown). End caps 12 further includes a recessed surface, relative to the planar surface, with mounting hole 22. Mounting hole 22 is spaced from and adjacent to attachment hole 20A. Mounting hole 22 is commonly used to mount a support for a front portion of motorcycle operator floorboards located on either side of the motorcycle. In general, a mounting arm 10 is designed to replace the stock floorboard support and attach to each end cap 12 to support the front portion of the operator floorboards (one of which is partially shown diagrammatically in phantom) and to provide a mounting point for an operator foot peg assembly 24, as will be described below in greater detail.

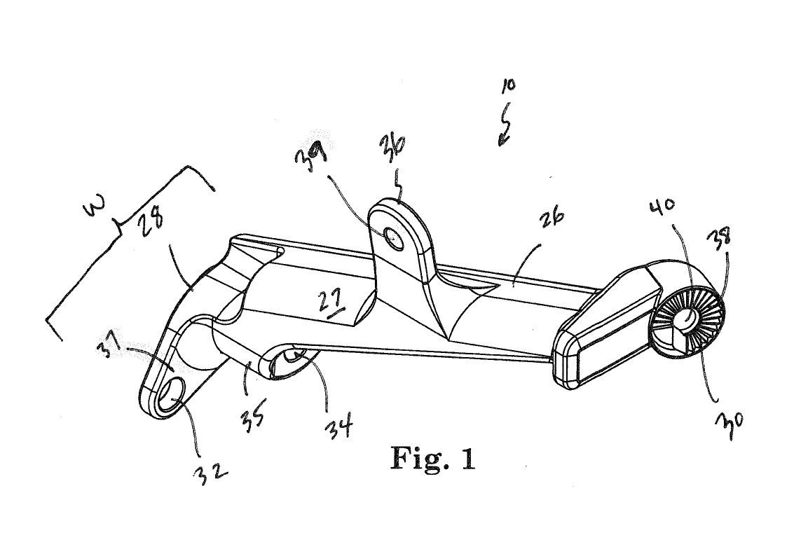

FIG. 1 is a side perspective view of one example of a mounting arm 10, which is configured for mounting to a right side end cap of a touring motorcycle. It should be appreciated that a mounting arm 10 intended for mounting to the left side end cap is a mirror image of the mounting arm 10 shown in FIG. 1. As shown in FIG. 1, one embodiment of mounting arm 10 generally includes a support arm body 26, an attachment base 28 at a first end of the body 26, for attachment of the body 26 to the end cap 12 (FIG. 6), and mounting site 30 at a second end of body 26, for mounting the motorcycle operator foot peg assembly 24 (FIG. 6). In one embodiment, the attachment base 28 has a width W that is greater than a width of body 26, and is configured with a pair of spaced attachment bores 32, 34 for attaching body 26 to the end cap 12. Alternatively, body 26 could have any width equal to or greater than base 28. Bore 34 extends from base 28 through a portion 35 of body 26, which in one embodiment has a length of about 1.4 inches, whereas bore 32 extends through a wall portion 37 of the base that extends laterally from the body and has a wall thickness of about 0.25 inches. Attachment bores 32 and 34 are located for alignment with mounting hole 20B and mounting hole 22 of end cap 12, respectively, for connection of mounting arm 10 with threaded connectors, such as bolts. The body 26 includes a tab 36 that extends from upper surface 27 at a location spaced from the base 28 and includes an attachment hole 39 to provide a connection to a floorboard mounting slot (not shown) when the mounting arm 10 is connected to the end cap 12. By way of example, the center of the hole 39 of tab 36 is located about 3.9 inches from the base 28. The mounting site 30 is spaced from the mounting tab 36 a distance sufficient to locate the mounting site 30 beyond the floorboard outer edge. By way of example, the mounting site 30 is spaced from tab 36 about 3.15 inches. In one embodiment, tab 36 has a width of about 0.95 inches and a curved upper edge with a radius of about 0.5 inches. In one embodiment, the mounting site 30 includes a splined mounting face 38 and an internally threaded central mounting hole for connecting a foot peg assembly 24. Mounting arm 10 is formed from cast metal, such as steel. In one exemplary embodiment, body 26 has a length of about 7.0 inches and a width of about 1.4 inches.

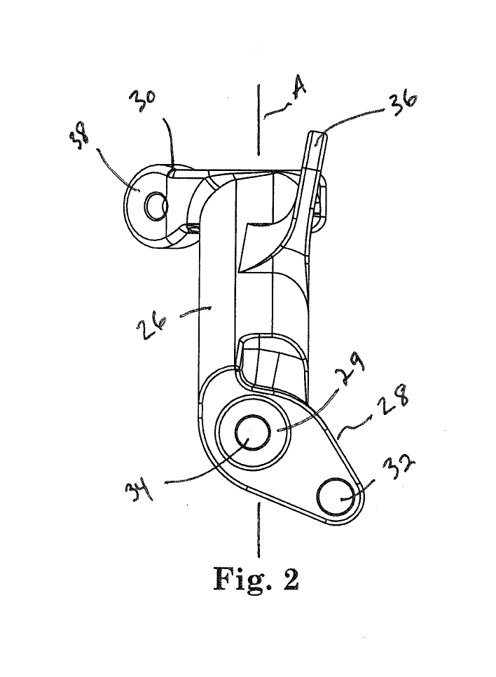

FIG. 2 is an end perspective view of the mounting arm 10 of FIG. 1. As shown in FIG. 2, in the embodiment shown the body 26 extends from base 28 at an elevated angle along an axis A that generally passes through mounting hole 34. In general the angle of axis A is selected to locate tab 26 for connection to one end of the floorboard, and to locate mounting site 30 beyond an outer edge of the floorboard. In one embodiment, tab 36 is eccentric to axis A in a first direction and is oriented to align with and connect to the mounting structure of the motorcycle floorboard. In one embodiment, tab 36 is oriented at an angle of about 10° relative to axis A. In the embodiment shown, the mounting site 30 extends generally normal to axis A, and includes a portion 38 corresponding to the splined mounting face that is eccentric to axis A in a second direction. Other orientations of portion 38 relative to axis A and tab 36 are also possible.

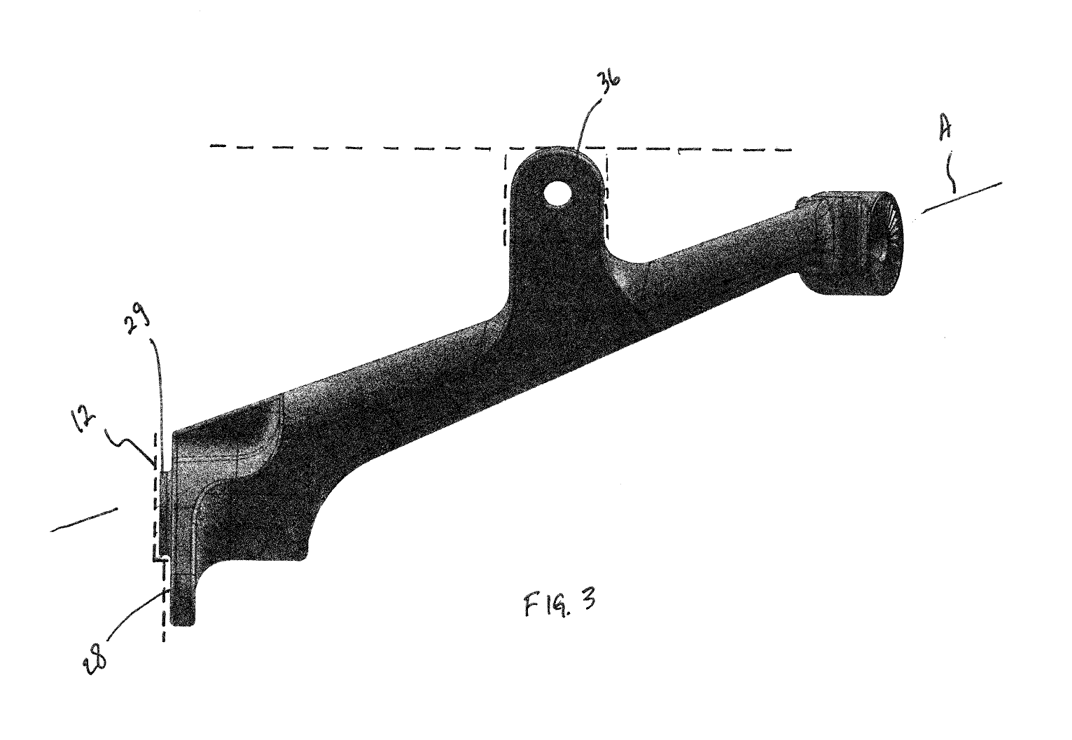

FIG. 3 is a rear side elevation of mounting arm 10 with a side surface portion of end cap 12 shown diagrammatically in dashed lines. As shown in FIGS. 2 and 3, to accommodate the stepped surface of end cap 12 where mounting hole 22 is located, the base 28 is provided with a raised shoulder 29 that surrounds attachment bore 34. In one embodiment, the raised shoulder 29 extends about 0.12 inch from end surface of base 28. As further shown in FIG. 3, in the exemplary embodiment shown, axis A of body 26 extends at an angle relative to the end surface of base 28 that is selected to locate tab 36 for connection to a floorboard (shown diagrammatically in dashed lines) and to position the mounting site 30 where a foot peg assembly can be mounted without interfering with the floorboard. The body 26 of mounting arm 10 may have other shapes and forms suitable to support a front portion of a floorboard and locate a mounting site 30 for a foot peg assembly that does not interfere with the floorboard. In an alternative embodiment, mounting site 30 may be located at any location relative to tab 36 that enables a foot peg assembly to be mounted to mounting site 30.

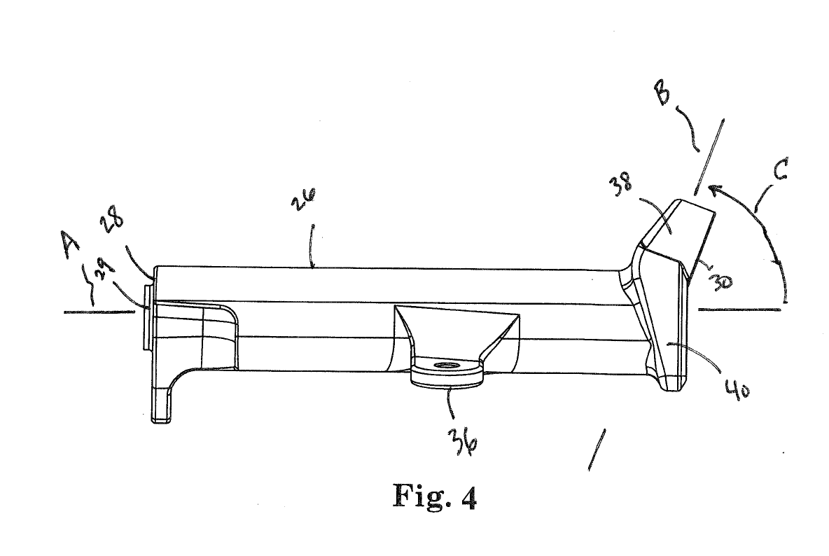

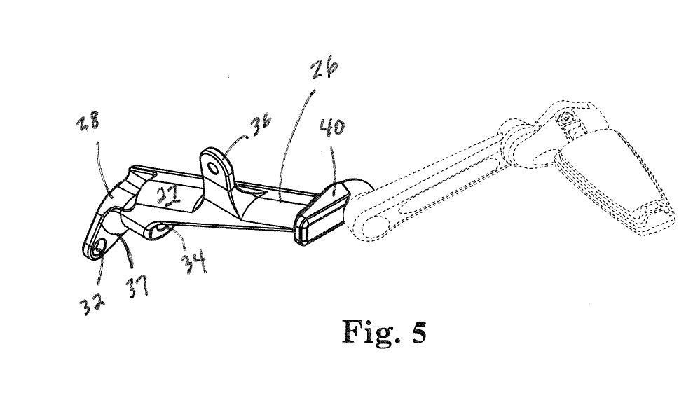

FIG. 4 is a top side view of the mounting arm 10. As shown in FIG. 4, in one embodiment, the mounting site 30 is connected to end 40 of body 26 such that it lies along an axis B, which is disposed at an angle C relative to axis A. The angle C is selected to provide clearance for a foot peg assembly connected to mounting site 30 relative to the fairing lowers. In one embodiment, angle C is about 70°. FIG. 5 is a perspective view of mounting arm 10 with one version of a foot peg assembly 24 (shown in phantom) that includes a linear support arm. By way of example, axis B defines an orientation of mounting site 30 and the splined mounting face 38, and hence the orientation of the linear support arm of the foot peg assembly 24. The angle formed by axis A and axis B depends on the configuration of foot peg assembly 24, but generally is selected to ensure that the foot peg assembly 24 extends laterally away from fairing lowers. In one embodiment, angle C is an acute angle. Other orientations of axis B relative to axis A are also possible.

Referring again to FIG. 6, mounting arm 10 connects to a motorcycle frame 14 via end cap 12 to provide support for a front portion of an operator footboard and to provide a point of connection for a foot peg assembly 24 that is rearward of the roll bar and not as wide as the roll bar. Unlike standard footboard mounting apparatus, which mounts only to mounting hole 22 of end cap 12, mounting arm 10 connects to end cap 12 at two locations, namely, attachment hole 20A and mounting hole 22. Thus, attachment hole 20A, which was designed to attach a portion of end cap 12 to the motorcycle frame 14, is utilized to attach a portion of mounting arm 10 and end cap 12 relative to the motorcycle frame 14. The mounting base 28 of mounting arm 10 therefore provides two points of connection for mounting arm 10 to the motorcycle frame 14, which provides a rigid connection that prevents any significant rotation of the mounting arm 10 about axis A due to the moment caused by the weight of an operator's legs resting on the foot peg of assembly 24. The mounting arm 10 provides an alternate location on a touring motorcycle for mounting a foot peg assembly that is closer to the motorcycle footboard than the typical foot peg assembly mounting location on the motorcycle roll bar, which, depending on the length of a motorcycle operator's legs, permits a more convenient and a more comfortable location for a foot peg. Thus, the mounting arm 10 eliminates the need to mount a foot peg to the roll bar.

A motorcycle mounting arm has been described as having an arm body with a first end that has first and second attachment locations for connecting the mounting arm to the frame of the motorcycle via the end cap of the motorcycle. The arm body has a second end spaced from the first end that has a mounting site for connecting a foot peg assembly, such as a secondary arm that carries a clevis and a foot peg. The arm body has a tab between the first and second ends that is connectable to a portion of a motorcycle floorboard. The arm body extends at an angle relative to the first and second attachment locations to locate the tab for connection to the floorboard and locates the second end for connection to a foot peg assembly when the mounting arm is attached to the motorcycle.

Although the mounting arm has been described with reference to preferred embodiments, workers skilled in the art will recognize that changes can be made in form and detail without departing from the spirit and scope of the disclosed mounting arm. Applicant intends that the examples described above do not limit the scope of applicant's invention, which is defined by the claims below. Applicant's descriptions are not intended to redefine the terms set forth in the claims unless applicant has expressly stated that a term means something different than the plain import of the terms.

What is claimed is:

1. A motorcycle mounting arm comprising:
an arm body having length, a first end and a second end spaced from the first end, the first end having first and second attachment locations for connecting the mounting arm to an end cap of the motorcycle, the second end having a mounting site for a foot peg assembly, the arm body further having a tab between the first and second ends, the tab being connectable to a portion of a motorcycle floorboard, wherein an axis of the arm body lies at an angle relative to the first and second attachment locations.

2. The motorcycle mounting arm of claim 1, wherein a portion of the mounting surface is eccentric to the axis in a first direction.

3. The motorcycle mounting arm of claim 1, wherein the first attachment location is generally aligned with the axis, and wherein the second attachment location is eccentric to the axis.

4. The motorcycle mounting arm of claim 3, wherein the first attachment location comprises a bore, the bore extending through a portion of the body.

5. The motorcycle mounting arm of claim 1, wherein the portion of the body has a length of about 1.4 inches.

6. The motorcycle mounting arm of claim 1, wherein the mounting site is eccentric to the axis in a second direction.

7. The motorcycle mounting arm of claim 2, wherein the mounting site is eccentric to the axis in a second direction different from the first direction.
